(19) United States
(12) Patent Application Publication
(10) Pub. No.: US 2011/0267443 A1
(43) Pub. Date: Nov. 3, 2011

(54) APPARATUS FOR DETECTING STRAY LIGHT IN LENS MODULE

(75) Inventor: TSUNG-YU LIN, Tu-Cheng (TW)

(73) Assignee: HON HAI PRECISION INDUSTRY CO., LTD., Tu-Cheng (TW)

(21) Appl. No.: 12/859,265

(22) Filed: Aug. 19, 2010

(30) Foreign Application Priority Data
Apr. 30, 2010 (TW) 99113765

(51) Int. Cl. H04N 7/18; G01N 21/01

(52) U.S. Cl. 348/61; 356/244; 348/E07.085

(57) ABSTRACT

An exemplary apparatus for detecting stray light in an lens module includes a worktable having a top surface, a protractor dial defined in the top surface, a lens module supporting seat on the top surface, a light source supporting seat on the top surface, a track defined in the top surface along a circumference of the dial, a light source on the light source supporting seat, an image pick-up unit. The dial includes an origin point and many scale lines. The lens module supporting seat is arranged on the top surface at the origin point for supporting the lens module. The light source is movable along the track, and configured for emitting light along a scale line towards the lens module. The image pick-up unit is configured for capturing images of the light from the light source through the lens module at respective different incident angles.

### BACKGROUND

1. Technical Field

The present disclosure relates to lens modules and, particularly, to an apparatus for detecting stray light in a lens module.

2. Description of Related Art

With the development of optical imaging technology, image capturing devices are widely used in electronic devices, such as digital cameras, mobile phones, etc. Naturally, there is always a demand for better quality pictures.

A lens module is an important component in these image capturing devices, and the quality of the lens module usually determines the quality of images captured by these image capturing devices. Therefore, it is important to detect stray light in a lens module for evaluating the quality of the image capturing device. Prior apparatuses for detecting stray light in lens modules usually only detect the stray light corresponding to a certain angle, and the stray light in the lens module corresponding to other angles are not taken into account, which results in less accurately determining the quality of the lens module.

What is needed, therefore, is an apparatus for detecting stray light in lens module which can solve the above problems.

### BRIEF DESCRIPTION OF THE DRAWINGS

FIG. 1 is a schematic view of an apparatus for detecting stray light in a lens module according to an exemplary embodiment.

FIG. 2 is a sectional view of a worktable and a lens module supporting seat of the apparatus of FIG. 1.

FIG. 3 is an exploded schematic view of a light source supporting seat of the apparatus of FIG. 1.

### DETAILED DESCRIPTION

Embodiments will now be described in detail below with reference to the drawings.

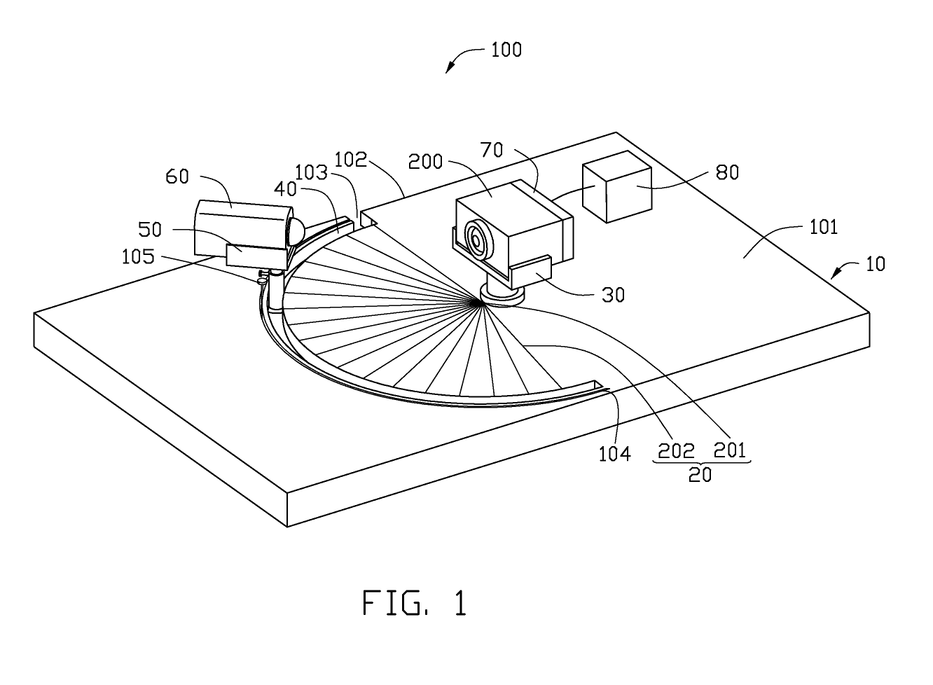

Referring to FIG. 1, an apparatus 100 for detecting stray light in a lens module 200, in accordance with an exemplary embodiment, is shown. The lens module 200 includes at least one lens (not shown). The apparatus 100 includes a worktable 10 having a top surface 101, a protractor dial 20 defined in the top surface 101, a lens module supporting seat 30 arranged on the top surface 101, a track 40 defined in the top surface 101 along a circumference of the protractor dial 20, a light source supporting seat 50 arranged on the top surface 101, a light source 60 arranged on the supporting seat 50, an image pick-up unit 70, and a processing unit 80 electrically connected with the pick-up unit 70.

The protractor dial 20 includes an origin point 201 and a plurality of scale lines 202 extending radially from the origin point 201.

The supporting seat 30 is arranged on the top surface 101 at the origin point 201 of the protractor dial 20 for supporting the lens module 200. In the present embodiment, the supporting seat 30 is fixed on the top surface 101.

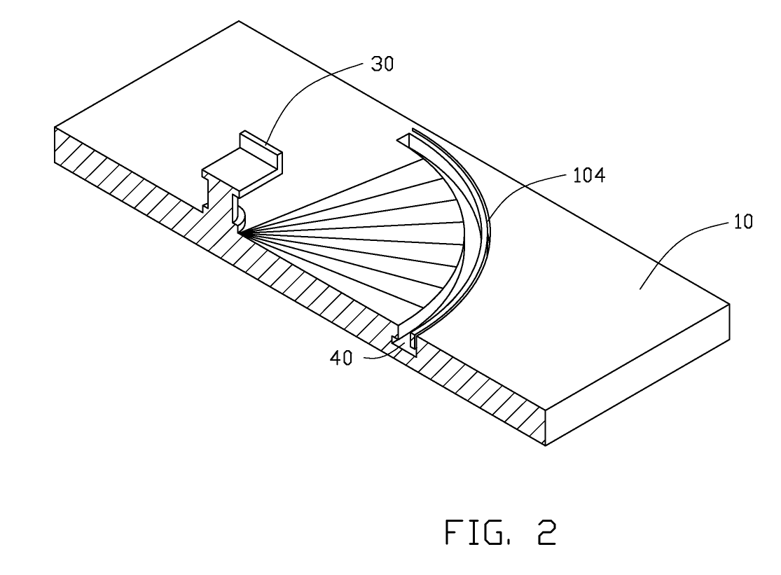

Referring also to FIG. 2, in the present embodiment, the track 40 is a semicircular groove with a narrow upper portion and a wide bottom portion (i.e. the radial width of the upper portion is less than that of the bottom portion), and is connected with the supporting seat 50 by the scale lines 202.

The worktable 10 also includes an opening 103 defined in a side surface 102 of the worktable 10. The side surface 102 is adjoining the top surface 101. The opening 103 communicates with the track 40, thereby allowing the supporting seat 50 to conveniently be installed into the track 40.

Preferably, the top surface 101 of the worktable 10 further defines a groove 104 parallel and communicating with the track 40. A first fixing member 105 (see FIG. 1) passes through the groove 104, enters into the track 40, and is tightly sandwiched between the side wall of the supporting seat 50 and the side wall of the track 40. Thus, the supporting seat 50 can be fixed to a certain position on the track 40, thereby making the measurement of the stray light easier. In alternative embodiments, the top surface 101 of the worktable 10 may be defined as a plurality of spaced grooves communicating with the track 40 for alternatively receiving the first fixing member 105, thereby making the supporting seat 50 alternatively fixed to different positions on the track 40. In further alternative embodiments, there may be no groove 104. In such case, the first fixing member 105, which is alternatively received in the track 40 at different positions, can also fix the supporting seat 50 to different positions on the track 40.

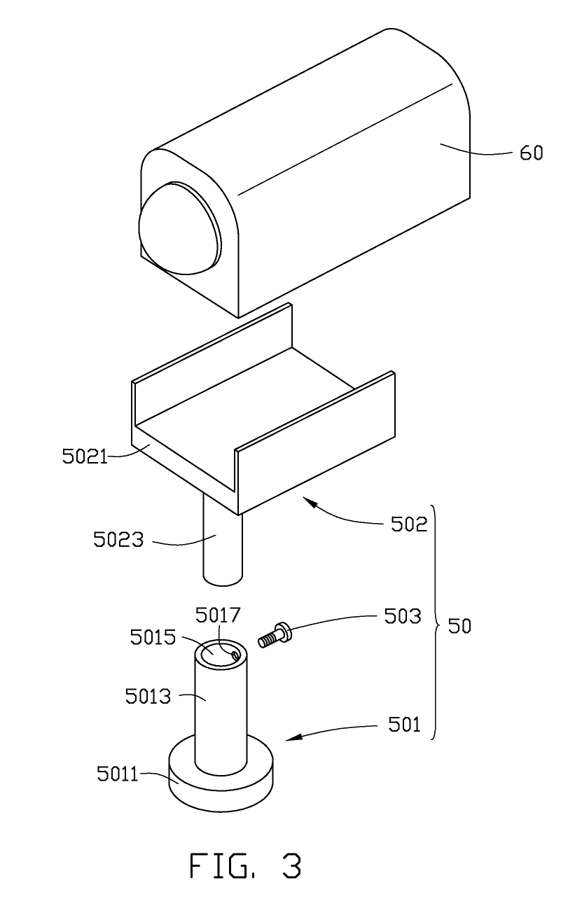

The supporting seat 50 is movable in the track 40. Referring to FIG. 3, the supporting seat 50 includes a bottom supporting portion 501, a top supporting portion 502 arranged on the bottom supporting portion 501 and movable relative the bottom supporting portion 501, and a second fixing member 503.

The bottom supporting portion 501 is moveable in the track 40. The bottom supporting portion 501 includes a bottom 5011, and a hollow receiving body 5013 arranged on the bottom 5011. A receiving cavity 5015 is defined in the receiving body 5013. The receiving cavity 5015 is configured for receiving the top supporting portion 502. A receiving hole 5017 communicating with the receiving cavity 5015 is defined in the side wall of the receiving cavity 5015. The receiving hole 5017 is configured for receiving the second fixing member 503.

In the present embodiment, the bottom 5011 is round in shape, and the hollow receiving body 5013 is a cylindrical body. The diameter of the bottom 5011 is slightly larger than the radial width of the bottom portion of the track 40. The outer diameter of the receiving body 5013 is slightly larger than the radial width of the top portion of the track 40.

The top supporting portion 502 includes a supporting stage 5021 for supporting the light source 60, and a supporting body 5023 arranged on the bottom surface of the supporting stage 5021 for supporting the supporting stage 5021. The supporting body 5023 is received in the receiving cavity 5015, and is movable relative to the receiving body 5013.

The second fixing member 503 is detachable from the bottom supporting portion 501, and is configured for fixing the supporting body 5023 at a certain height relative to the top surface 101. When the second fixing member 503 is tightly received in the receiving hole 5017, and contacts with the supporting body 5023, the supporting body 5023 will be fixed at a certain height relative to the top surface 101 by the second fixing member 503. In the present embodiment, the second fixing member 503 is a screw, and the receiving hole 5017 is a threaded hole. In alternative embodiments, the second fixing member 503 may be a cylindrical body with a slippery outer sidewall. In further alternative embodiments, the second fixing member 503 may be inserted into the receiving cavity 5015 along the direction parallel with the lengthwise direction of the receiving body 5013, and be tightly sandwiched between the outer sidewall of the supporting body 5023 and the inner wall of the receiving body 5013, thereby fixing the supporting body 5023 at a certain height relative to the top surface 101.

The light source 60 is movable along the track 40 and rotatable on the track 40, and configured for emitting light along a scale line 202 towards the lens module 200. In the present embodiment, the light source 60 is an incandescent lamp. In other embodiments, the light source 60 may be a light emitting diode, or another kind of light source.

The pick-up unit 70 is disposed at an image-side of the lens module 200 for capturing images of the light from the light source through the lens module 200 at respective different incident angles relative to the optical axis (not shown) of the lens module 200, and delivering the image to the process unit 80. The pick-up unit 70 can be a charge-coupled device (CCD) or a complementary metal oxide semiconductor device (CMOS). The pick-up unit 70 can be selected from a group consisting of ceramic leaded chip carrier (CLCC) package type image pick-up units, plastic leaded chip carrier (PLCC) package type image pick-up units, and chip scale package (CSP) type image pick-up units.

The process unit 80 is electrically connected with the image pick-up unit 70. The process unit 80 receives the images from the image pick-up unit 70, analyzes the images, determines the incident angles where stray light occurs in the lens module 200, and measures an intensity of the stray light at the corresponding incident angle. In other embodiments, the process unit 80 may be omitted. In such case, images from the image pick-up unit 70 at respective different incident angles can be analyzed by a person to determine whether stray light occurs at the corresponding incident angles and how the corresponding stray light is formed.

The scale lines 202 can accurately indicate the incident angles between light from light source 60 and the optical axis of the lens module 200 when the stray light occurs. The reason of the occurrence of the stray light can thus be accurately analyzed. In addition, the height between the supporting stage 5021 and the bottom 5011 can be adjusted. The apparatus 100 can thus detect stray light in different kinds of lens modules (i.e. different heights of lens modules). Accordingly, the use rate of the apparatus 100 is improved.

A method for detecting stray light in the lens module 200 includes the following steps.

The apparatus 100 is provided, and the lens module 200 is positioned on the supporting seat 30.

The supporting seat 50 is positioned in the track 40 from the opening 103, and the light source 60 is positioned on the supporting seat 50.

It is then determined whether the light source 60 is substantially coplanar with the lens module 200. If the light source 60 is not substantially coplanar with the lens module 200, the second fixing member 503 can be detached from the receiving hole 5017, and the supporting body 5023 is moved along the lengthwise direction of receiving body 5013 until the light source 60 is substantially coplanar with the lens module 200. Then, the light source 60 is rotated, thereby making the light source 60 emit light along a scale line towards the lens module 200. Next, the second fixing member 503 is tightly received in the receiving hole 5017, and contacts with the supporting body 5023.

Then, the supporting seat 50 is moved in the track 40, and the pick-up unit 70 senses lights from the lens module 200 corresponding to many incident angles, forms images corresponding to many incident angles, and delivers the corresponding images to the process unit 60.

The process unit 80 receives the images, analyzes the images, determines the incident angles where stray light occurs in the lens module 200, and measures an intensity of the stray light at the corresponding incident angle.

While certain embodiments have been described and exemplified above, various other embodiments will be apparent to those skilled in the art from the foregoing disclosure. The disclosure is not limited to the particular embodiments described and exemplified but is capable of considerable variation and modification without departure from the scope and spirit of the appended claims.

What is claimed is:

1. An apparatus for detecting stray light in a lens module, comprising:
a worktable having a top surface;
a protractor dial defined in the top surface, the protractor dial including an origin point and a plurality of scale lines extending radially from the origin point;
a lens module supporting seat arranged on the top surface at the origin point of the protractor dial for supporting the lens module;
a light source supporting seat, the light source supporting seat being arranged on the top surface;
a track defined in the top surface along a circumference of the protractor dial;
a light source arranged on the light source supporting seat, the light source being movable along the track, and configured for emitting light along a scale line towards the lens module, and
an image pick-up unit for capturing images of the light from the light source through the lens module at respective different incident angles.

2. The apparatus of claim 1, wherein the lens module supporting seat is fixed on the top surface.

3. The apparatus of claim 1, further comprising an opening defined in a side surface of the worktable, the side surface adjoining the top surface, the opening communicating with the track.

4. The apparatus of claim 1, further comprising a first fixing member for fixing the light source supporting seat to a certain position on the track.

5. The apparatus of claim 1, wherein the light source supporting seat comprises a bottom supporting portion, and a top supporting portion arranged on the bottom supporting portion and movable relative the bottom supporting portion, the bottom supporting portion is movable in the track, the top supporting portion comprises a supporting stage for supporting the light source.

6. The apparatus of claim 5, wherein the bottom supporting portion further comprises a bottom substrate and a hollow receiving body arranged on the bottom substrate, and the hollow receiving body defines a receiving cavity for receiving the top supporting portion.

7. The apparatus of claim 6, wherein the top supporting portion further comprises a supporting body under the supporting stage for supporting the supporting stage, the supporting body is received in the receiving cavity.

8. The apparatus of claim 7, further comprising a second fixing member for fixing the top supporting portion at a certain height relative to the top surface.

9. An apparatus for detecting stray light in a lens module, comprising:
a worktable having a top surface;
a protractor dial defined in the top surface, the protractor dial including an origin point and a plurality of scale lines extending radially from the origin point;
a lens module supporting seat arranged on the top surface at the origin point of the protractor dial for supporting the lens module;
a light source supporting seat, the light source supporting seat being arranged on the top surface;
a track defined in the top surface along a circumference of the protractor dial;
a light source arranged on the light source supporting seat, the light source being movable along the track, and configured for emitting light along a scale line towards the lens module;
an image pick-up unit for capturing images of the light from the light source through the lens module at respective different incident angles, and
a processing unit electrically connected with the image pick-up unit, the processing unit being configured for analyzing the images and determining the incident angles where stray light occurs in the lens module.

10. The apparatus of claim 9, wherein the processing unit is configured for measuring an intensity of the stray light at the corresponding incident angle.

11. The apparatus of claim 9, further comprising an opening defined in a side surface of the worktable, the side surface adjoining the top surface, the opening communicating with the track.

12. The apparatus of claim 9, further comprising a first fixing member for fixing the light source supporting seat to a certain position on the track.

13. The apparatus of claim 9, wherein the light source supporting seat comprises a bottom supporting portion, and a top supporting portion arranged on the bottom supporting portion and movable relative the bottom supporting portion, the bottom supporting portion is movable in the track, the top supporting portion comprises a supporting stage for supporting the light source.

14. The apparatus of claim 13, wherein the bottom supporting portion further comprises a bottom substrate and a hollow receiving body arranged on the bottom substrate, and the hollow receiving body defines a receiving cavity for receiving the top supporting portion.

15. The apparatus of claim 14, wherein the top supporting portion further comprises a supporting body under the supporting stage for supporting the supporting stage, the supporting body is received in the receiving cavity.

16. The apparatus of claim 15, further comprising a second fixing member for fixing the top supporting portion at a certain height relative to the top surface.

17. An apparatus for detecting stray light in a lens module, comprising:
a worktable having a top surface;
a protractor dial defined in the top surface, the protractor dial including an origin point and a plurality of scale lines extending radially from the origin point;
a lens module supporting seat arranged on the top surface at the origin point of the protractor dial for supporting the lens module;
a track defined in the top surface along a circumference of the protractor dial;
a light source movable along the track and rotatable on the track, the light source configured for emitting light along a scale line towards the lens module;
an image pick-up unit for capturing images of the light from the light source through the lens module at respective different incident angles, and
a processing unit configured for analyzing the images and determining the incident angles where stray light occurs in the lens module.

18. The apparatus of claim 17, further comprising an opening defined in a side surface of the worktable, the side surface adjoining the top surface, the opening communicating with the track.

19. The apparatus of claim 17, further comprising a first fixing member for fixing the light source supporting seat to a certain position on the track.

20. The apparatus of claim 17, wherein the light source supporting seat comprises a bottom supporting portion, and a top supporting portion arranged on the bottom supporting portion and movable relative the bottom supporting portion, the bottom supporting portion is movable in the track, the top supporting portion comprises a supporting stage for supporting the light source.
